(19) United States
(12) Patent Application Publication
(10) Pub. No.: US 2012/0254041 A1
(43) Pub. Date: Oct. 4, 2012

(54) ONE-TIME CREDIT CARD NUMBERS

(75) Inventors: Ashutosh Saxena, Hyderabad (IN); Harigopal K.B. Ponnapalli, Hyderabad (IN)

(73) Assignee: Infosys Technologies Ltd., Bangalore (IN)

(21) Appl. No.: 13/109,946

(22) Filed: May 17, 2011

(30) Foreign Application Priority Data
Mar. 31, 2011 (IN) 1062/CHE/2011

(51) Int. Cl. G06Q 20/00; G06Q 40/00

(52) U.S. Cl. 705/64; 705/44

(57) ABSTRACT

Various technologies related to one-time credit card numbers are presented. One-time credit card numbers can originate from a customer device and be independently generated by the customer device without online communication with an issuer. Signed transaction details can also be sent, providing non-repudiation of the purchase transaction. Merchant infrastructure need not be changed to accommodate the one-time credit card numbers. The technologies can be particularly resilient to replay, forgery, man-in-the-middle, and guessing attacks for credit card number generation or other usage by an attacker.

### BACKGROUND

Credit card based payments have remained fundamentally unchanged since the early 1980's. With the advent of the Internet, credit card use has grown by leaps and bounds, but so has fraud.

So, despite numerous technical advances, credit card fraud continues to plague on-line commerce. Although there are many possible variations, a typical case of fraud involves use of another's credit card without consent or knowledge. The fraudster has no intention of contacting the rightful owner of the card or ever paying for the purchases made.

While the exact amount of losses due to credit card fraud is unknown, some estimates are at the $5,000,000,000 level. Further, as e-commerce volume continues to grow, fraudsters adopt more complex schemes. The types of fraud range from lost or stolen cards to identity theft, skimming, counterfeit cards, mail interception, and others.

Although some technologies have evolved to address credit card fraud, there remains room for improvement.

### SUMMARY

A variety of techniques are described for one-time credit card numbers.

As described herein, a one-time credit card number can originate from a user device. Both offline and online purchase transactions can be supported.

A shared secret can be used to generate the one-time credit card number.

Transaction details can be signed with a private key of the customer, providing non-repudiation of the purchase transaction.

A one-time credit card number application can be provided to the customer by an issuer by which the customer can generate credit card numbers without further information from the issuer.

One-time credit card numbers can take the format of a conventional credit card number. So, merchants can continue to process purchase transactions with conventional infrastructure.

As described herein, a variety of other features and advantages can be incorporated into the technologies as desired.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary system implementing the one-time credit card technologies described herein.

FIG. 2 is a flowchart of an exemplary method of implementing the one-time credit card technologies described herein from a customer perspective.

FIG. 3 is a flowchart of an exemplary method of implementing the one-time credit card technologies described herein from a merchant perspective.

FIG. 4 is a flowchart of an exemplary method of implementing the one-time credit card technologies described herein from an issuer perspective.

FIG. 5 is a block diagram of an exemplary system implementing provisioning for the one-time credit card number technologies described herein via a one-time credit card application.

FIG. 6 is a flowchart of an exemplary method of implementing provisioning for the one-time credit card technologies described herein via a one-time credit card application from a customer perspective.

FIG. 7 is a flowchart of an exemplary method of implementing registration for the one-time credit card technologies described herein via a one-time credit card application from an issuer perspective.

FIG. 8 is a block diagram of an exemplary one-time credit card number application.

FIG. 9 is a block diagram of an exemplary system implementing the one-time credit card number technologies described herein via a shared secret and public/private key cryptography.

FIG. 10 is a flowchart of an exemplary method of implementing the one-time credit card number technologies described herein from a customer perspective.

FIG. 11 is a flowchart of an exemplary method of implementing the one-time credit card number technologies described herein from an issuer perspective.

FIG. 12 is a block diagram of an exemplary system generating a one-time credit card number.

FIG. 13 is a flowchart of an exemplary method of generating a one-time credit card number.

FIG. 14 is a block diagram of an exemplary system configured to sign transaction details.

FIG. 15 is a flowchart of an exemplary method of signing transaction details.

FIG. 16 is a block diagram of an exemplary system verifying a transaction involving a one-time credit card number.

FIG. 17 is a flowchart of an exemplary method of verifying a transaction involving a one-time credit card number via signed transaction details, a shared secret, and a.

FIG. 18 is a flowchart of an exemplary method of verifying a one-time credit card number via a shared secret.

FIG. 19 is a flowchart of an exemplary method of verifying a one-time credit card number transaction details via a public key.

FIG. 20 is a block diagram of an exemplary system implementing initial setup for one-time credit cards at an issuer.

FIG. 21 is a flow diagram of an exemplary method implementing issuance of a one-time credit card.

FIG. 22 is a flow diagram of an exemplary method of using a one-time credit card.

FIG. 23 is a block diagram of an exemplary computing environment suitable for implementing any of the technologies described herein.

### DETAILED DESCRIPTION

### Example 1

### Exemplary Overview

The technologies described herein can be used for a variety of one-time credit card scenarios. The merchant infrastructure for processing credit card numbers need not be changed because the one-time credit card can take the form of an ordinary credit card. Such an approach can be particularly beneficial because merchants are more likely to accept a technology that requires few or no changes to their infrastructure.

### Example 2

### Exemplary Customer Device

In any of the examples herein, a customer device can be any collection of one or more computing devices capable of storage and processing that a customer can use to effect a purchase transaction with a credit card number. Such devices can be under control of the customer. In practice, the customer is an individual purchasing goods or services in an online or offline purchase transaction scenario. The individual may act on behalf of herself (e.g., a private person) or a business entity.

As described herein, the customer device can be at a different location than other devices (e.g., issuer device, merchant device, or the like). Such a location can be a location remote from the other devices.

Typically, a customer device takes the form of a mobile or handheld computing device, including smartphones, tablet computers, e-readers, and the like. However, desktop and other computing devices can also be used to implement the technologies.

For the sake of convenience, the customer device is sometimes simply called the “customer.”

### Example 3

### Exemplary Merchant Device

In any of the examples herein, a merchant device can be any collection of one or more computing devices capable of processing a credit card number for effecting a transaction with a customer. Such devices can be under control of the merchant. In practice, the merchant is a business entity selling goods or services in an online or offline purchase transaction scenario. The business entity may be a single person or a legal entity such as a corporation, partnership, sole proprietorship, municipality, or the like. Certain legal considerations enter into the transaction, typically including an obligation to pay for the goods or services, which can be fulfilled by providing the one-time credit card number, which ultimately is to result in transfer of funds to the merchant.

Typically, a merchant device takes the form of server device(s) designed to receive requests for services and implement such requests. In practice, a merchant may delegate such functions to a service provider. For example, the merchant may avail itself of a service for processing credit card transactions, while maintaining control over such functions.

For the sake of convenience, the merchant device is sometimes simply called the “merchant.”

### Example 4

### Exemplary Issuer Device

In any of the examples herein, an issuer device can be any collection of one or more computing devices capable of processing a request for credit card number approval for effecting a transaction between a customer and a merchant. Such devices can be under control of the issuer. In practice, the issuer can be a bank or other financial institution that supports online and offline purchase transaction scenarios. Typically, a legal relationship between the issuer and the customer exists by which the customer has an obligation to pay for those purchase transactions effected by credit card number(s) associated with the issuer.

Typically, an issuer device takes the form of server device(s) designed to receive requests for approval of transactions and respond to such requests. Due to the volume of requests, a server farm or other load balancing technique involving a large number of devices can be used.

In practice, an issuer may delegate such functions to a service provider. For example, the issuer may avail itself of a service for approving credit card transactions, while maintaining control over such functions. Similarly, the device(s) themselves may be operated and/or maintained by a third-party while under control of the issuer.

For the sake of convenience, the issuer device is sometimes simply called the “issuer.” Although the issuer can still control approval of transactions, the issuer need not issue a physical credit card, and the issuer need not issue card numbers as described herein.

### Example 5

### Exemplary One-Time Credit Card Number

In any of the examples herein, a one-time credit card number can be of the format of a standard credit card number (sometimes called a “bank card number”). A standard such as ISO/IEC 7812 bank card numbers can be used. Such a standard can have provisions for an issuer identification number, major industry identifier, (e.g., part of the issuer identification number), a variable length individual account number, one or more check digits, and the like. For example, sixteen-digit numbers used by issuers such as Visa, MasterCard, and the like can be used. Fifteen-digit number used by issuers such as American Express can be used. Thirteen-digit number used by issuers such as Visa can be used.

The syntax of the issuer can also be observed. For example, certain issuers have certain blocks of numbers assigned to them (e.g., American Express numbers start with “37” or “34”). Also, credit card numbers can be generated such that they comply with a validation scheme, such as a checksum (e.g., a Luhn validation).

By using such an approach, merchants can accept and otherwise process one-time credit card numbers described herein without changing infrastructure for processing such numbers. Thus, an infrastructure-transparent one-time credit card number can be used as described herein.

Credit card security codes can also be included in card generation. Generally, security codes are issued along with a credit card once along with issuance of the card. The technologies described herein can also follow the same procedure to issue the CVV, at the beginning while issuing the first time credit card number to user. The security codes can remain unchanged for a specific period, as being practiced, and can be changed with the existing mechanism/process in place.

Credit card security codes can be generated according to issuer convention, such as encrypting card information (e.g., credit card number, expiration date, and service code) with an encryption key. The expiration date can be set for the current month or some other date. Alternatively, a special card security code or codes can be used for one-time credit card numbers.

### Example 6

### Exemplary Dual Control

In any of the examples herein, the one-time credit card number can be generated independently by both the customer and the issuer. Such a scenario is sometimes called “dual control” or “dual generation” because two parties (e.g., customer and issuer) can control generation of the one-time credit card number. As described herein, dual control enables use of one-time credit card numbers without having to gather information (e.g., the card number) from the issuer at the time of the purchase transaction. The one-time credit card number need not be provided (e.g., by the issuer or issuer device) to the customer device before generation by the customer device.

### Example 7

### Exemplary System Employing a Combination of the Technologies

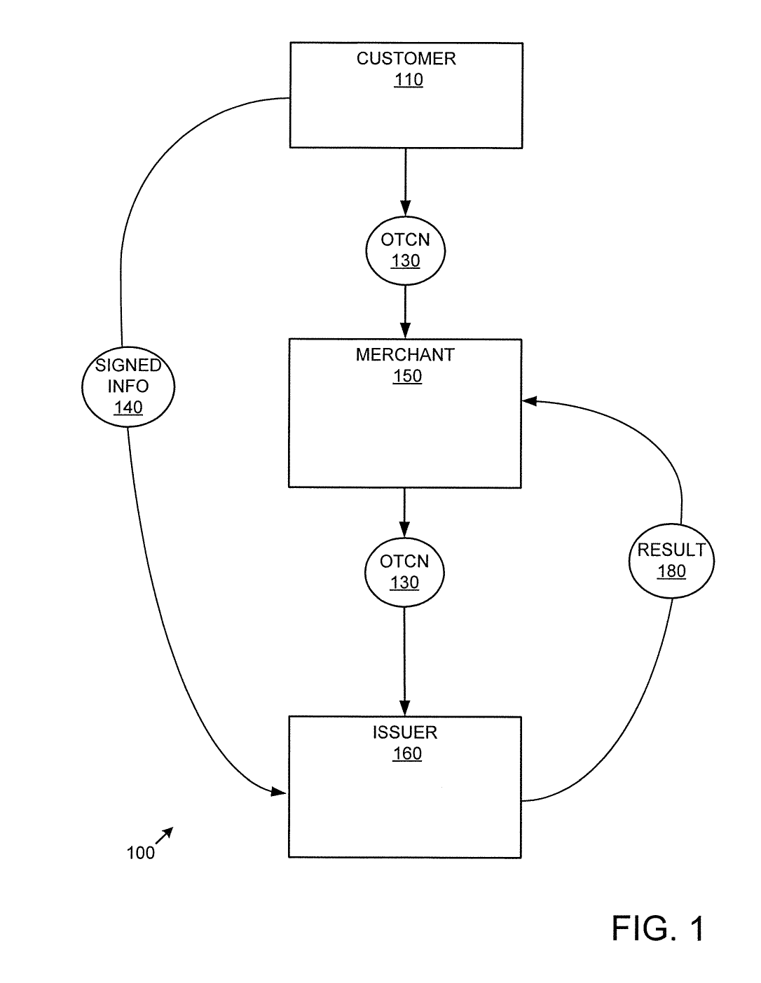

FIG. 1 is a block diagram of an exemplary system 100 implementing the one-time credit card number technologies described herein.

In the example, a customer computing device 110 provides a one-time credit card number 130 to a merchant device 150 as part of a purchase transaction between a customer and a merchant. Accordingly, the customer device 110 and the merchant device 150 can be linked via a communications network in an online transaction scenario. However, the technologies can support scenarios where there is no such communication link between the devices, or where such a communication link is not used.

As described herein, both online and offline transaction scenarios can be supported. In the case of an offline transaction, a human intermediary may operate between the devices (e.g., to type in the number).

The merchant device 150 typically is linked via a communications network with the issuer device 160. The merchant device 150 can then request approval of transactions involving the one-time credit card number 130 by sending a request for approval of the transaction to the issuer device 160. Such a request can include transaction details as described herein. An approval result 180 can also be provided over such a communications network. Typically, such a result indicates whether or not the transaction is approved by the issuer.

The customer device 110 and the issuer 160 can be linked via a communications network, by which signed information 140 (e.g., details) about the transaction can be sent from the customer device 110 to the issuer 160. As described herein, the channel by which the signed information 140 is sent can be different from the channel, if any, by which the one-time credit card number 130 is sent from the customer device 110 to the merchant device 150 (or from the merchant device 150 to the issuer 160). Alternatively, the signed information 140 can be sent to the merchant device 150 and forwarded to the issuer device 160 by the merchant (e.g., the information 140 passes through the merchant device 150).

In addition to the one-time credit card verification technologies described herein, the merchant may wish to apply other information when deciding whether to approve the purchase transaction. Although not shown, the issuer 160 can maintain information about the customer, such as whether a current agreement is in place, a credit limit, and the like.

In practice, the systems shown herein, such as system 100 can be more complicated, with additional functionality, more complex communications, and the like.

In any of the examples herein, the information (e.g., one-time credit card number 130, the signed information 140, and the result 180) can be stored in one or more computer-readable storage media or one or more computer-readable storage devices.

### Example 8

### Exemplary Method of Applying a Combination of the Technologies: Customer Perspective

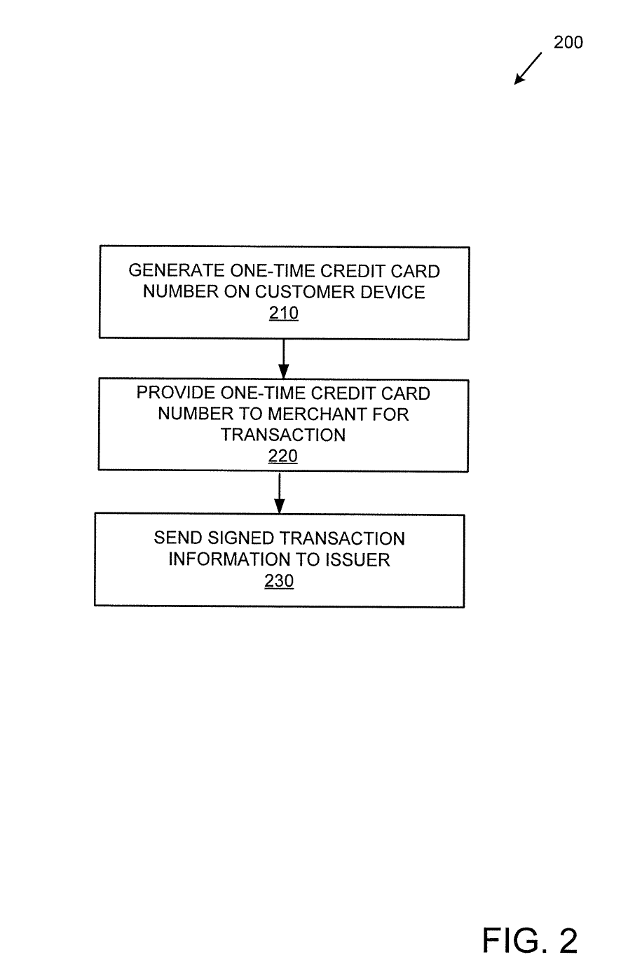

FIG. 2 is a flowchart of an exemplary method 200 of implementing the one-time credit card number technologies described herein from a customer perspective and can be implemented, for example, in a customer device such as that shown in FIG. 1. The technologies described herein can be generic to the specifics of operating systems or hardware and can be applied in any variety of environments to take advantage of the described features.

At some point, the process is invoked, such as responsive to a customer request for a new one-time credit card number for a purchase transaction.

At 210, a one-time credit card number is generated for a purchase transaction on a customer device using any of the techniques described herein. As described herein, the number can be generated without receiving any information from the issuer (e.g., after the process is invoked).

At 220, the one-time credit card number is provided to the merchant device for the purchase transaction.

At 230, signed transaction information (e.g., purchase transaction details for a purchase being made by the customer from the merchant) are sent to the issuer. Such transaction information can be received and then signed (e.g., using a private key of the customer) before being sent.

The method 200 and any of the methods described herein can be performed by computer-executable instructions stored in one or more computer-readable media (e.g., storage or other tangible media) or one or more computer-readable storage devices.

### Example 9

### Exemplary Different Channels

In any of the examples herein, different channels (e.g., communication channels) can be used to communicate different pieces of information. Different channels can include Internet, short message service (SMS), private network, electronic mail, physical mail, voice over wired network, voice over wireless network, and the like. However, the same channel can also be used.

Some channels are called “out of bound” because they are outside the bounds of another. For example, SMS is typically out of bound from an Internet channel.

### Example 10

### Exemplary Purchase Transaction Details

In any of the examples herein, purchase transaction details can include any combination of the identity of the customer (e.g., customer name and/or ID) involved in the purchase transaction (e.g., in control of the customer device), amount of the transaction, the one-time credit card number, the identity of the merchant (e.g., merchant ID), shipping address, transaction ID, and the like.

The purchase transaction details involved in the technologies can incorporate existing practice (e.g., whatever transaction details are currently being used in purchase transactions involving credit cards). A digital signature of the customer can also be included.

### Example 11

### Exemplary Lack of Online Access to Information from Issuer by Customer

In any of the examples herein, the one-time credit card number can be generated without online access to information from the issuer. For example, the one-time credit card number can be generated by the customer device (e.g., with a one-time credit card number application) rather than being acquired from the issuer. The one-time credit card number need not be provided to the customer device by the issuer (or any device controlled by the issuer). Thus, the number can be generated by an application authorized by the issuer but without receiving additional information from the issuer (e.g., after receiving the application).

Such an arrangement can be particularly beneficial because on-line connectivity to the issuer is not required. Even in cases where signed information is sent from the customer device to the issuer, such information can be sent via a channel other than the Internet, so that transactions can be achieved in Internet off-line scenarios.

The techniques described herein can also operate without challenge-response mechanisms with the issuer for authentication.

### Example 12

### Exemplary Method of Applying a Combination of the Technologies: Merchant Perspective

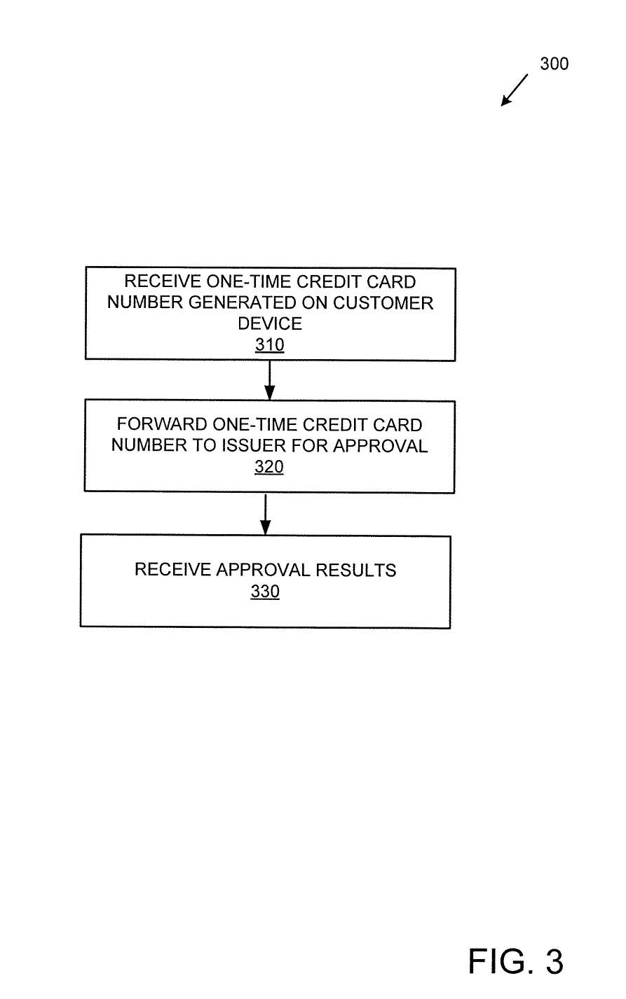

FIG. 3 is a flowchart of an exemplary method 300 of implementing the one-time credit card number technologies described herein from a merchant perspective and can be implemented, for example, in a merchant device such as that shown in FIG. 1.

At 310, a one-time credit card number generated on a device of a customer is received for a purchase transaction by the customer.

At 320, the one-time credit card number is forwarded to the merchant for approval. For example, the one-time credit card number can be included as part of a request for approval of the purchase transaction.

At 330, approval results of the request are received. In practice, if approval is indicated, then the purchase transaction by the customer is allowed to proceed. Otherwise, the transaction is rejected (e.g., the merchant can refuse the transaction, request a re-try, etc.).

### Example 13

### Exemplary Method of Applying a Combination of the Technologies: Issuer Perspective

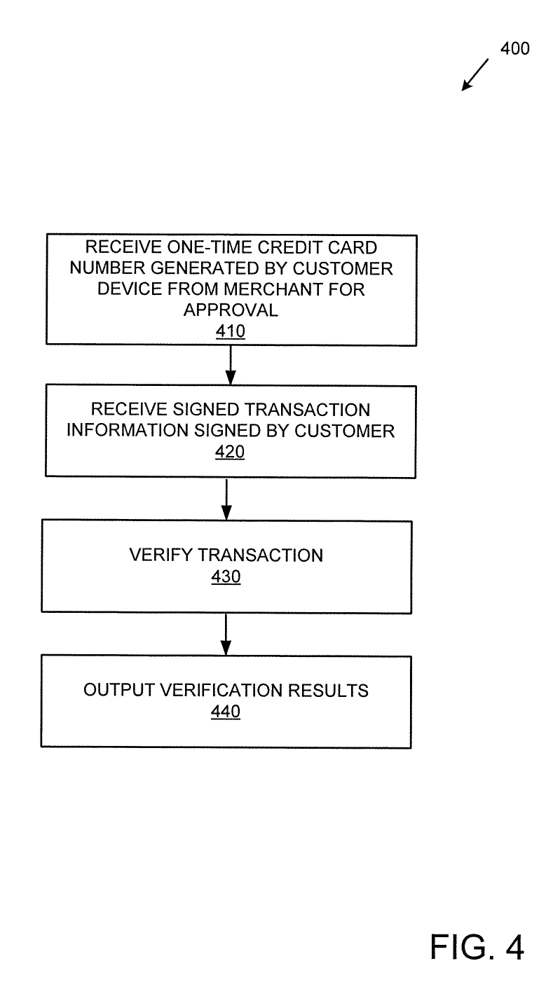

FIG. 4 is a flowchart of an exemplary method 400 of implementing the one-time credit card number technologies described herein from an issuer perspective and can be implemented, for example, in a system such as that shown in FIG. 1.

At 410, a one-time credit card number generated on a device of a customer is received for a purchase transaction being made by a customer via a customer device. As described herein, the transaction can be online or offline. In any of the examples herein, the purchase transaction can be between the customer and a merchant. The merchant sends the one-time credit card number to an issuer as part of an approval request for the purchase transaction.

As described herein, the one-time credit card number can originate from (e.g., be generated by) the customer device.

At 420, signed transaction information (e.g., transaction details) signed by the customer is received. As described herein, the signed transaction information can originate from (e.g., be signed by) the customer device.

At 430, the transaction is verified. Any of the verification techniques described can be implemented. A shared secret, public key, or both can be used as described herein.

At 440, results of the verification are output. Typically, the results indicate whether or not use of the one-time credit card number is valid. For example, responsive to determining that the number is valid, an indication of validity of the transaction can be output. The issuer can use such an output in combination with other data to determine whether or not to approve the purchase transaction between the customer and the merchant and provide an appropriate indication of approval to the merchant.

### Example 14

### Exemplary Offline and Online Transaction Scenarios

In any of the examples herein, both offline and online purchase transaction scenarios can be supported. In an offline purchase transaction, the transaction can be conducted without the customer device's being connected to the issuer device or the merchant device in an online fashion (e.g., an Internet connection to the issuer device is not used, an Internet connection to the merchant device is not used, or both). For example, for a transaction conducted offline, information can be provided to the merchant device via manual channels (e.g., by punching the number into a device by merchant personnel or the customer) or local (e.g., wireless) connection. Information such as signed transaction details can be sent to the issuer via SMS or some other channel.

An exemplary offline transaction is purchasing gasoline at a gasoline station. In such a case, the one-time credit card number can be generated and provided to the gasoline attendant, keypad, or wireless connection without use of an Internet connection. Other bricks-and-mortar style transactions can be supported in a similar offline fashion.

An exemplary online transaction is a customer browsing a merchant website. The user selects items for purchase (e.g., in an online shopping cart). For billing purposes, the customer is prompted to provide a credit card number. A one-time credit card number can be generated as described herein for use in such an online transaction.

### Example 15

### Exemplary One-Time Credit Card Number Capability Provisioning

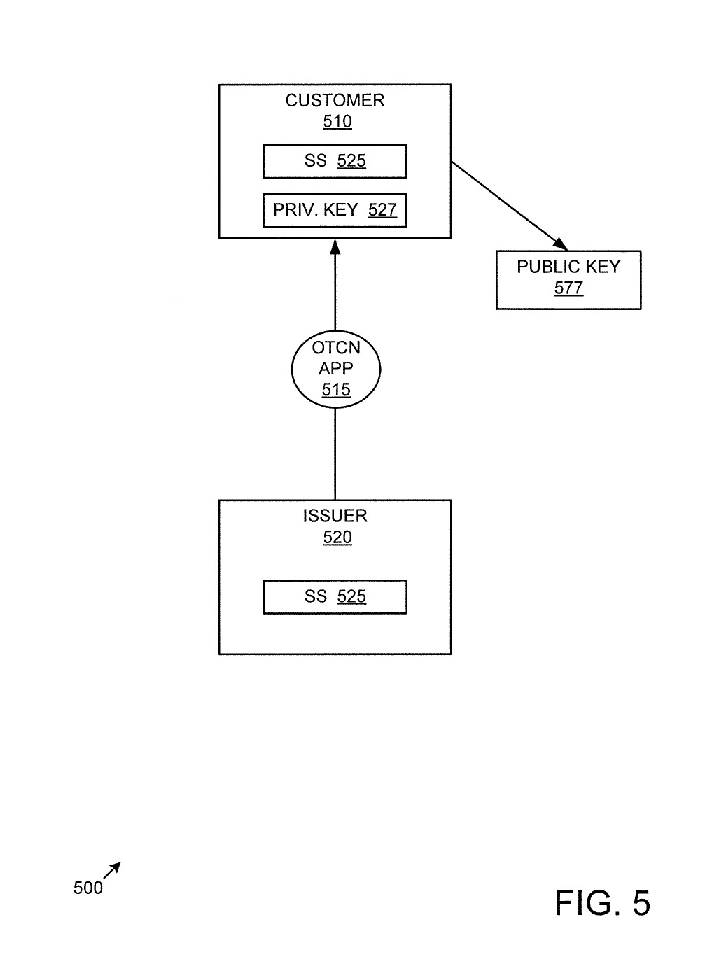

FIG. 5 is a block diagram of an exemplary system 500 provisioning one-time credit card number capability to a customer device 510. In the example, a one-time credit card number application 515 is sent from an issuer device 520 to a customer device 510. After successful provisioning, the one-time credit card number functionality can be used. Provisioning can be done as part of a registration or initialization process between the issuer and the customer. Functionality beyond that shown can be incorporated as described herein.

The issuer device 520 and the customer device 510 can be linked via a communications network by which the one-time credit card number application 515 can be sent from the issuer device 520 to the customer device 510. The link can be over a different channel than that used for other communications (e.g., different from the network over which one-time credit card numbers are sent).

The one-time credit card number application 515 can implement a shared secret 525, which is available at both the issuer device 520 and the customer device 510. In practice, the shared secret 525 can be embedded into the application 515 to avoid the customer tampering with it. Thus, the application 515 can be a personalized software program for a specific individual (e.g., the customer) that has a shared secret 525 between the issuer and the respective individual. The shared secret can be embedded into the application 515 (e.g., in the form of executables). The application can be targeted for any variety of platforms (e.g., Java .JAR file, .NET file, or the like).

To support the digital signature technologies described herein, public key/private key cryptographic techniques can be implemented. In such a case, the customer device 510 has access to a private key 527 (e.g., stored on the customer device 510), and a public key 577 of the customer is published (e.g., made available to others, including the issuer).

The shared secret 525 stored at the issuer device 520 can be associated with an identity of the customer or customer device 510 so that it can be retrieved for use during purchase transactions involving the customer or customer device 510.

The issuer can outsource the above provisioning process to any trusted third party who can act on behalf of the issuer.

### Example 16

### Exemplary Method of One-Time Credit Card Number Capability Provisioning: Customer Perspective

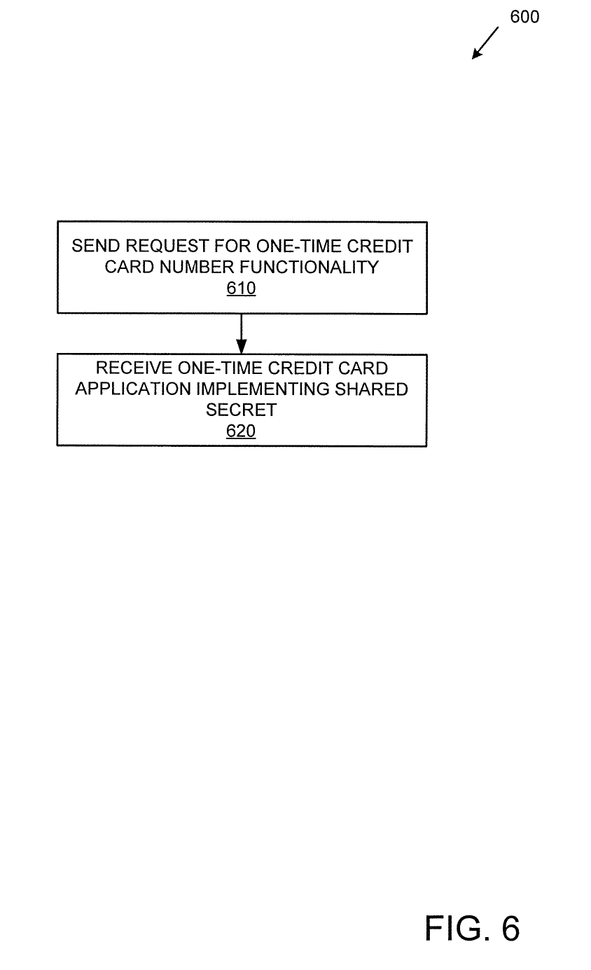

FIG. 6 is a flowchart of an exemplary method 600 of implementing provisioning for the one-time credit card technologies described herein via a one-time credit card generation application from a customer perspective and can be implemented, for example, in a system such as that shown in FIG. 5. The method 600 can be performed as part of an initial registration process for a customer who wants to make use of the one-time credit card technology.

At 610, a customer device sends a request for one-time credit card functionality to the issuer. As part of the process, the customer can establish identity with the issuer.

At 620, responsive to the request, the customer device can receive a one-time credit card application implementing a shared secret shared between the customer device and the issuer device.

As described herein, a public key (e.g., certificate) can also be provided by the customer to the issuer. Such a public key can be provided directly, or published through a third party. The corresponding private key of the customer remains a secret of the customer.

### Example 17

### Exemplary Method of One-Time Credit Card Number Capability Provisioning: Issuer Perspective

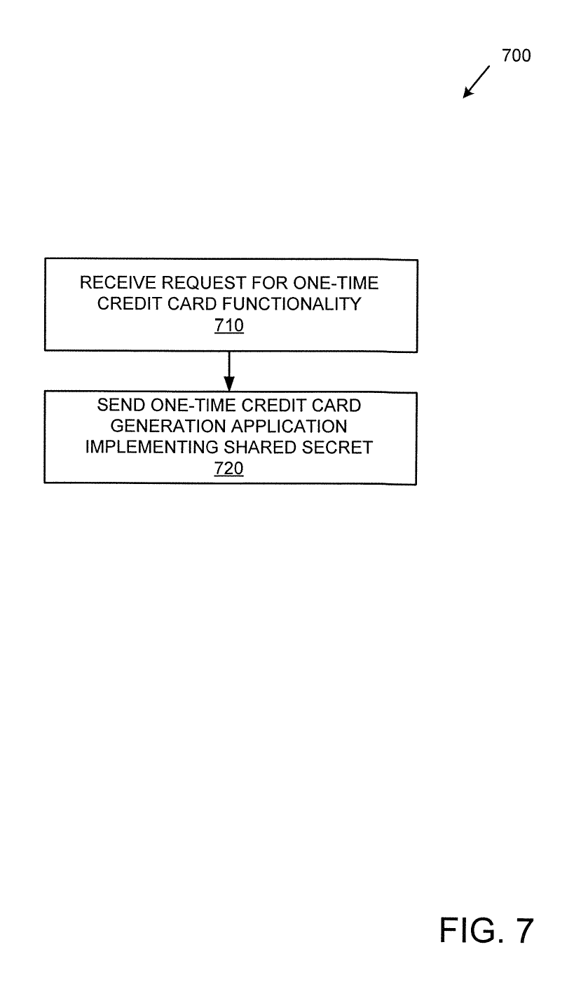

FIG. 7 is a flowchart of an exemplary method 700 of implementing provisioning for the one-time credit card technologies described herein via a one-time credit card generation application from an issuer perspective and can be implemented, for example, in a system such as that shown in FIG. 5.

At 710, a request for one-time credit card number functionality is received by the issuer from a customer device. As part of the process, the customer can establish identity with the issuer.

At 720, responsive to the request, the issuer device can send, to the customer device, a one-time credit card application implementing a shared secret shared between the customer device and the issuer device.

### Example 18

### Exemplary Shared Secret

In any of the examples herein, a shared secret can be shared between the customer device and the issuer device. In the interest of maintaining security, the secret is typically not shared with others.

The shared secret can take the form of digital data. For example, a unique random serial number can be generated for a respective user by an issuer server and shared with the one-time credit card number application that is installed on the customer device. Alternatively, a mobile device unique identification number of the customer device can be used as the shared secret. The one-time credit card number generation process can take this shared secret as one of the inputs to produce one-time credit card numbers.

### Example 19

### Exemplary One-Time Credit Card Number Application

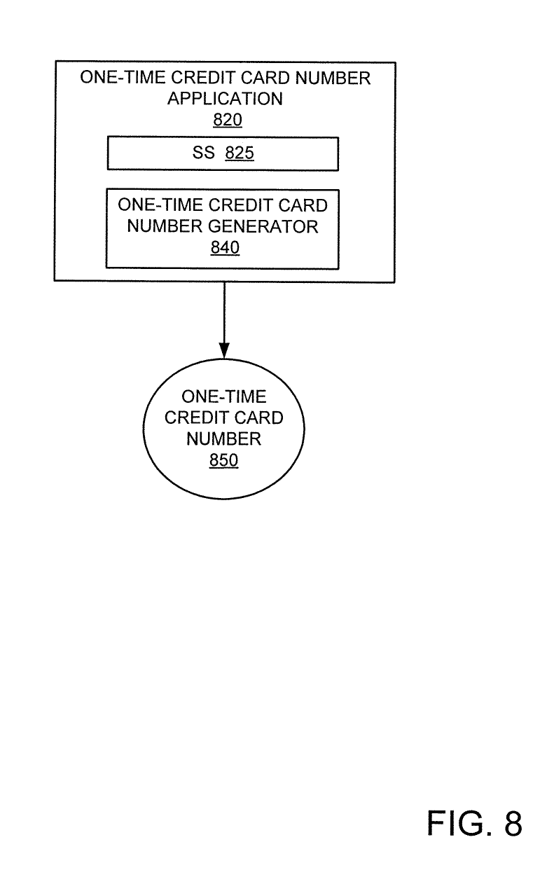

FIG. 8 is a block diagram of an exemplary one-time credit card number application 820 that can be used in any of the examples herein.

In the example, the application 820 is operable to generate a one-time credit card number 850 according to any of the techniques described herein. The application 820 can include access to a shared secret 825 and a one-time credit card number generator 840 according to any of the examples described herein.

The application 820 can include additional functionality for implementing the one-time credit card number technologies described herein. For example, private/public key cryptographic functionality, transaction detail collecting functionality, and the like can be included in the application 820. Although such functionality is sometimes described as integrated in a single application 820, it is possible to divide the functionality. For example, functionality can be placed into standalone applications, integrated into other applications, implemented as plug-ins, and the like.

In practice, the one-time credit card number application can be protected by a password or other mechanism to prevent execution by unauthorized persons. For example, a certain passcode (e.g., password or username/password combination) may be required to be entered before execution or generation of a one-time credit card number. Responsive to receiving the correct passcode, the application can execute and subsequently provide the number for a purchase transaction.

### Example 20

### Exemplary Identity of Customer

In any of the examples herein, the identity of a customer can be the customer name, a customer number, or some other identifier identifying the identity of the customer. The customer name can be of a format that would ordinarily appear on a credit card, such as first name and last name and possibly a middle name or initial (e.g., “John Q Public”).

### Example 21

### Exemplary System Implementing One-Time Credit Card Numbers

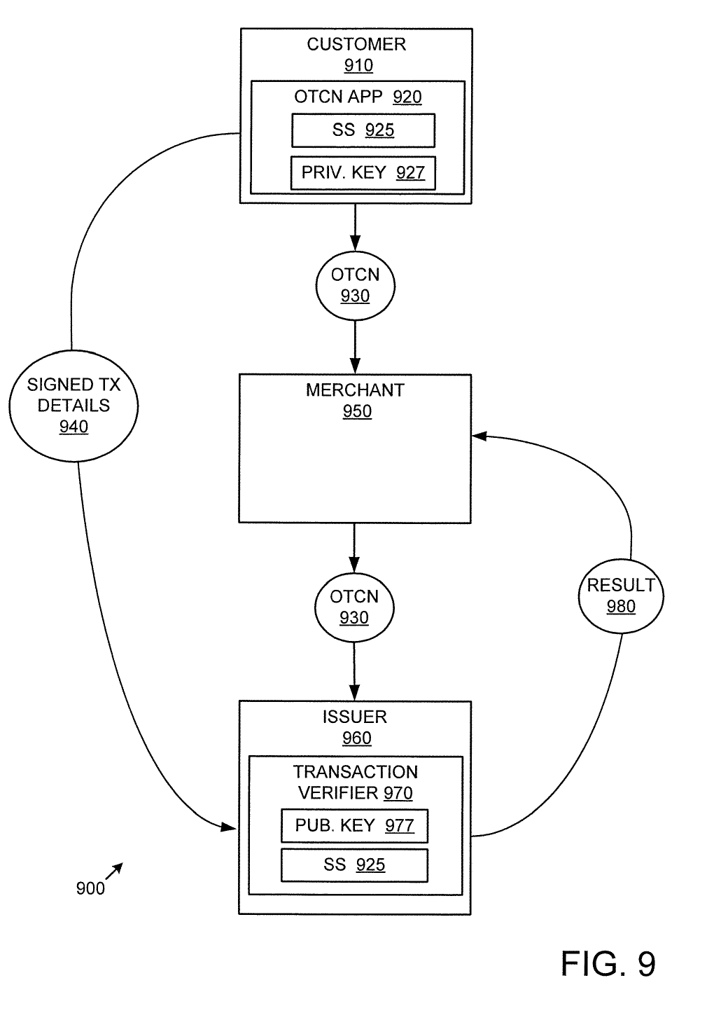

FIG. 9 is a block diagram of an exemplary system 900 implementing the one-time credit card number technologies described herein via a shared secret 925 and public/private key cryptography). Communications arrangements similar to those of FIG. 1 can be implemented.

In the example, a customer device 910, a merchant device 950, and an issuer device 960 cooperate to implement a purchase transaction between the customer and the merchant via a one-time credit card number 930.

The customer device 910 can execute a one-time credit card number application 920, which includes access to a shared secret 925 shared between the customer device 910 and the issuer device 960. The application 920 also has access to a private key 927 of the customer.

The merchant device 950 can operate as normally with any other credit card number. Changes to the infrastructure for handling credit card numbers need not be implemented.

The issuer 960 can include a transaction verifier 970, which has access to the shared secret 925 and a public key 977 of the customer.

The signed transaction details 940 can be signed via the private key 927 and verified via the public key 977.

An approval result 980 can be communicated from the issuer device 960 to the merchant device 950.

As in FIG. 1, the signed transaction details 940 can pass though the merchant device 950 or be communicated from the customer device 910 to the issuer device 960 without passing through the merchant device 950.

### Example 22

### Exemplary Method of Implementing One-Time Credit Card Numbers: Customer Perspective

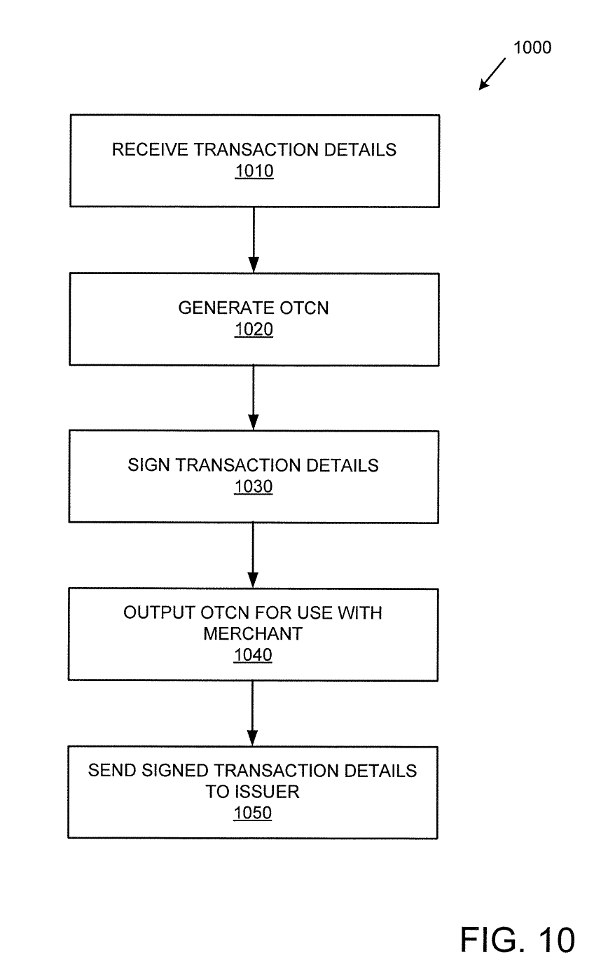

FIG. 10 is a flowchart of an exemplary method 1000 of implementing the one-time credit card number technologies described herein from a customer perspective and can be implemented, for example, in a system such as that shown in FIG. 9.

At 1010, details of a purchase transaction are received.

At 1020, a one-time credit card number is generated. For example, a one-time credit card number application can be used as described herein to generate the number at the client device.

At 1030, the purchase transaction details are digitally signed using a cryptographic technique (e.g., using a private key of the customer).

At 1040, the one-time credit card number is output for use with the merchant. For example, the number can be provided as part of an online or offline purchase transaction.

At 1050, the signed transaction details are sent to the issuer device. As described herein, a different channel can be used to communicate the signed transaction details from that used for communicating the one-time credit card number. For example, if the one-time credit card number is sent over the Internet, the signed details can be provided via SMS or the like.

Alternatively, the signed transaction details can be provided to the merchant, who then forwards them to the issuer. For example, a pop-up window can appear into which the signed transaction details are entered.

In response, the customer will typically receive some indication that the transaction was approved. For example, the merchant can provide a screen or email indicating that purchase transaction (e.g., order) is successfully completed.

### Example 23

### Exemplary Method of Implementing One-Time Credit Card Numbers: Issuer Perspective

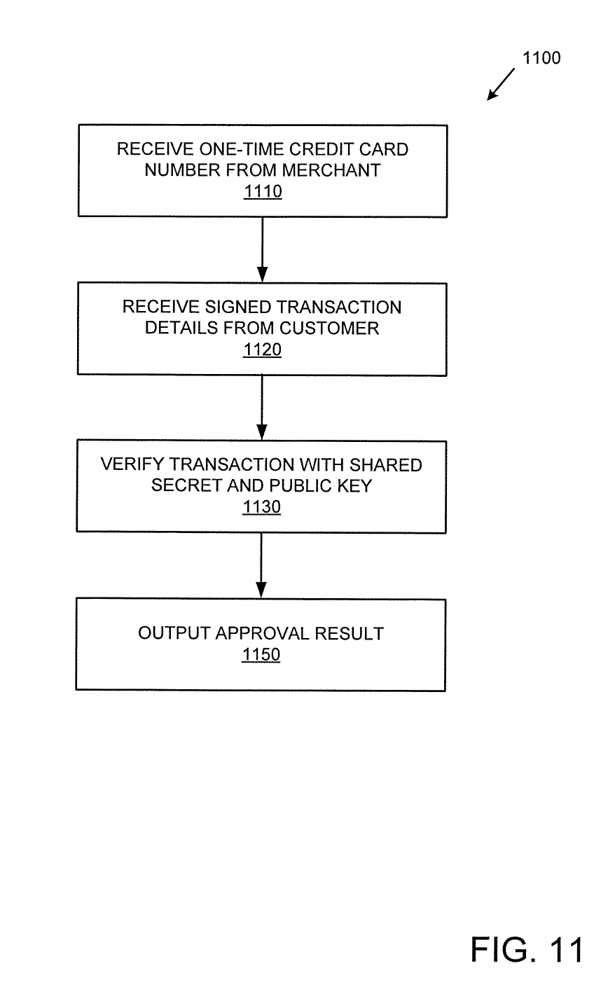

FIG. 11 is a flowchart of an exemplary method 1100 of implementing the one-time credit card number technologies described herein from a issuer perspective and can be implemented, for example, in a system such as that shown in FIG. 9.

At 1110, a one-time credit card number is received from a merchant device as part of a purchase transaction. The number can originate from a customer device and be generated as described herein.

At 1120, signed details of the purchase transaction are received by the issuer device from the customer device. The transaction details can be digitally signed as described herein.

At 1130, the transaction can be verified with a shared secret shared with the customer device and a public key of the customer. For example, the shared secret can be used to verify the credit card number (e.g., by generating a check one-time credit card number with the issuer device via the shared secret and checking if the two numbers match), and the public key can be used to verify the authenticity of the transaction details. The issuer can determine the customer identity (e.g., a client of the issuer) and determine the respective shared secret for the customer. The transaction details can also be determined from other sources (e.g., the incoming request for approval by the merchant device) and matched accordingly.

At 1150, an approval result is output. As part of the approval processes, results of the transaction verification can be included. For example, if the transaction is not verified (e.g., the credit card number does not match, the transaction details did not originate with the customer, or the like), the transaction is not approved. On the other hand, responsive to determining that the transaction is verified, the transaction can be approved. Approval can also include other considerations (e.g., whether the customer has sufficient remaining credit, whether the transaction indicates a purchase pattern or location associated with fraud, or the like).

### Example 24

### Exemplary Non-Repudiability of Transaction

In any of the examples herein, non-repudiation can be supported. For example, because the purchase transaction details are digitally signed with the customer's private key using cryptographic techniques, the customer cannot dispute that the transaction details were so signed (e.g., by the customer's device). Such digital signatures can be used in a court of law to establish the transaction. Accordingly, the purchase transaction cannot be repudiated by the customer.

Thus, the signed purchase transaction details can serve as a non-repudiable stamp for the usage, by the customer, of the valid one-time credit card number.

### Example 25

### Exemplary System Generating a One-Time Credit Card Number

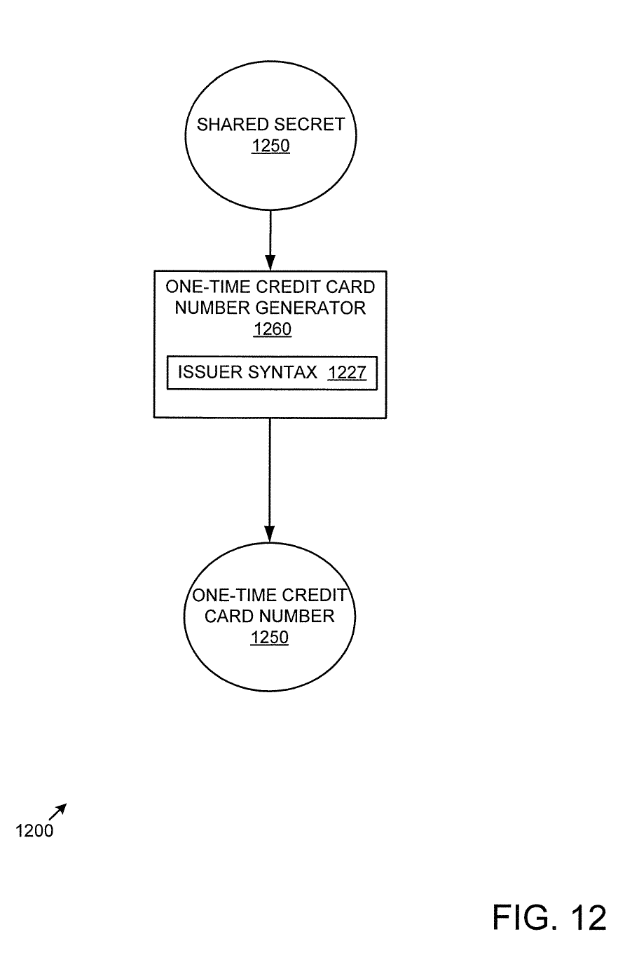

FIG. 12 is a block diagram of an exemplary system generating a one-time credit card number. In the example, a shared secret 1250 as described herein is used as input to a one-time credit card number generator 1260, which generates a one-time credit card number 1250 as described herein.

Input to the one-time credit card number generator 1260 can also include a seed value (e.g., stored at both the issuer and the customer). The seed value can change at both ends upon generation of a number (e.g., at the customer) and consumption of the number (e.g., at the issuer side).

The one-time credit card number generator 1260 can make use of logic pertaining to the syntax 1227 of the issuer, including the issuer identification number, compliance with a verification scheme, or the like.

As described herein, the one-time credit card number generator 1260 can reside on a client device. Thus, the client device can generate the one-time credit card number without having to contact the issuer (e.g., after the generator itself is obtained via download). The generator 1260 can also reside on the issuer device, enabling the issuer to also generate credit card numbers (e.g., to verify that they match the one supplied by the customer device).

### Example 26

### Exemplary Method of Generating a One-Time Credit Card Number

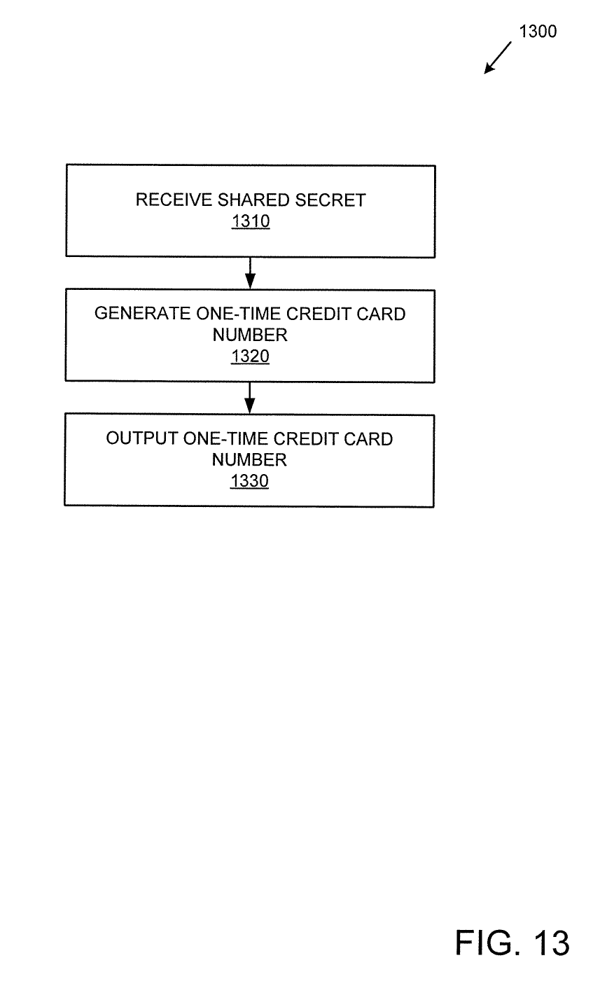

FIG. 13 is a flowchart of an exemplary method 1300 of generating a one-time credit card number and can be used, for example, in a system such as that shown in FIG. 12. In the example, the method results in output of a one-time credit card number according to any of the examples described herein. In practice, the same method can be performed by both a customer device and a issuer device (e.g., to generate the same number).

At 1310, a shared secret of a customer is received. The shared secret can be stored on the device on which the one-time credit card number is generated.

At 1320, a one-time credit card number is generated via the shared secret of the customer that is shared with the issuer. For example, cryptographic techniques can be used to generate certain digits of the credit card number via the shared secret. Other digits (e.g., the issuer identification number) can be generated according to issuer syntax. One or more check digits can be generated so that the number complies with a verification scheme associated with the issuer (e.g., a checksum or the like).

The techniques described for generating one-time credit card numbers can take collision avoidance into account. A unique shared secret between the customer and issuer can ensure that the possible credit card number for respective users be unique.

At 1330, the one-time credit card number is output. The number can be used to accomplish a purchase transaction or to verify that a provided number is valid.

### Example 27

### Exemplary System Signing Transaction Details

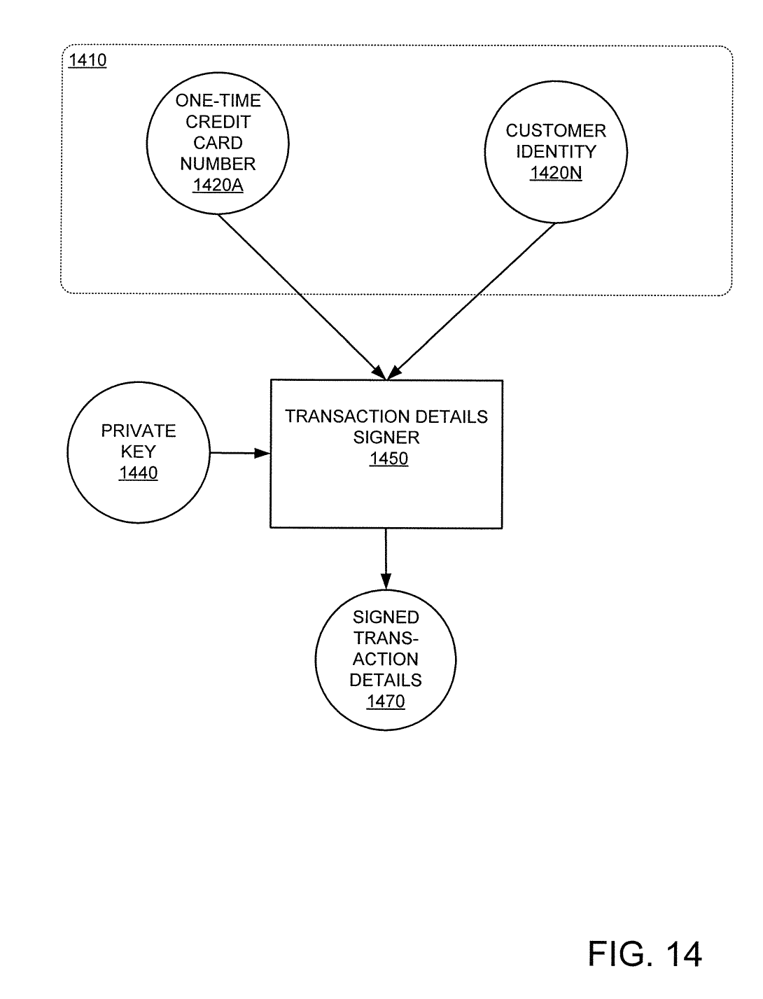

FIG. 14 is a block diagram of an exemplary system 1400 configured to sign transaction details. In any of the examples herein, purchase transaction details can be signed. Such an approach can provide non-repudiation of purchase transactions.

In the example, the transaction details 1410 are used as input to a transaction details signer 1450, which also uses a private key 1440 of the customer to generate the signed transaction details 1470. In practice, the signed transaction details 1470 can take the form of the details along with a digital signature by which authenticity of the details (e.g., the fact that the details were signed by the customer's private key) can be verified.

The transaction details 1410 can include any of the purchase transaction details described herein, such as the one-time credit card number 1420A and identity 1420N of the customer.

### Example 28

### Exemplary Method of Signing Transaction Details

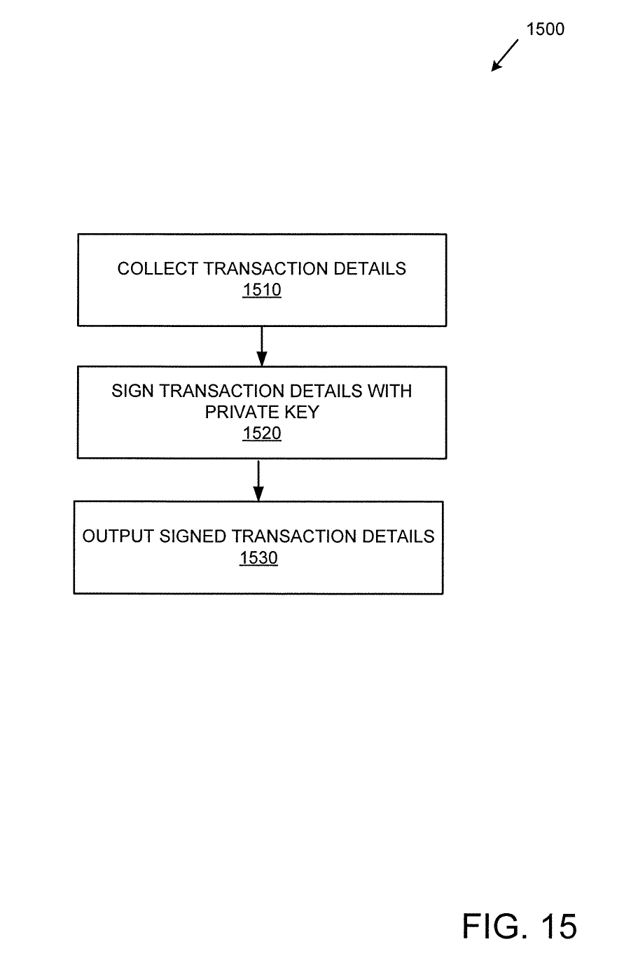

FIG. 15 is a flowchart of an exemplary method 1500 of signing transaction details and can be implemented, for example, in a system such as that shown in FIG. 14. In practice, the method 1500 is performed by a customer device, and the signed transaction details are sent to an issuer device as described herein.

At 1510, purchase transaction details are collected. The details can be collected by having a user manually enter the details. Some of the details can be stored by default. In other cases, the details can be collected by a separate application or plug-in, which scrapes the details from user input or web-based forms (e.g., while the user is shopping on a web site). Or, an application can simply allow the customer to enter the details. The one-time credit card number application can also assist by collecting such details.

At 1520, the transaction details are signed with a private key of the customer using a cryptographic technique.

At 1530, the signed transaction details are output. They can then be sent as described elsewhere herein.

### Example 29

### Exemplary System Verifying a Transaction Involving a One-Time Credit Card Number

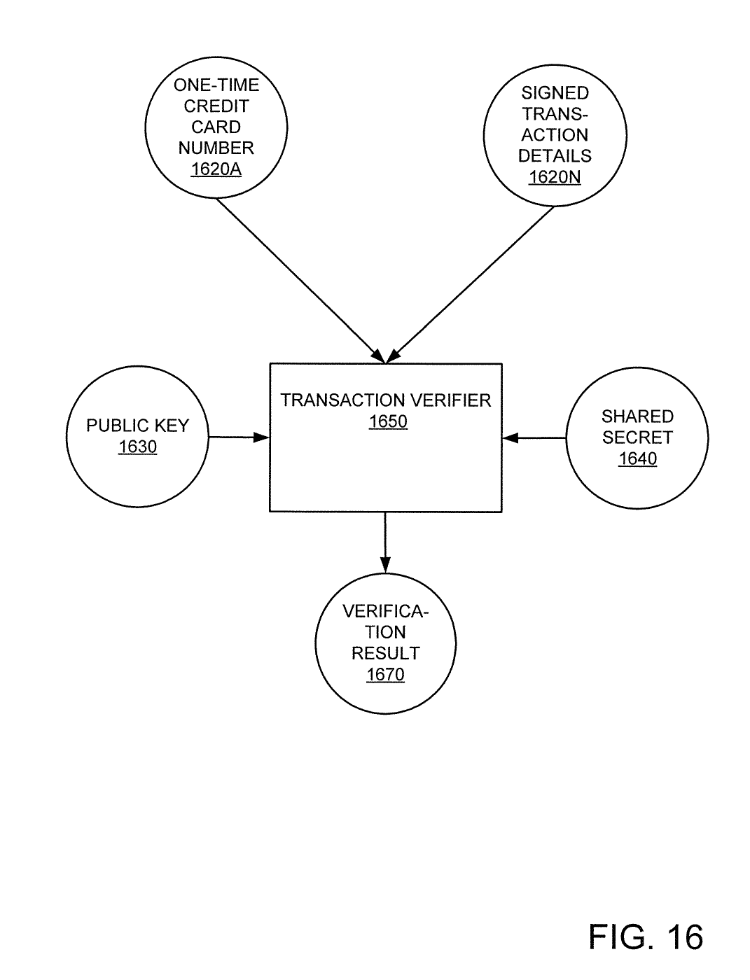

FIG. 16 is a block diagram of an exemplary system 1600 configured to verify a transaction involving a one-time credit card number. In practice, the system 1600 can be used by an issuer device to verify a purchase transaction as part of a transaction approval process in response to a request for approval.

In the example, a transaction verifier 1650 accepts a one-time credit card number 1620A received from a merchant machine as part of a purchase transaction approval request and signed transaction details 1620N received from a customer device (e.g., directly or via the merchant device).

The verifier 1650 also takes as input a public key 1630 of the customer (e.g., which has been published by the customer as is therefore available to the issuer) and a shared secret 1640 of the customer, which is shared by the customer and the issuer.

Based on the inputs, the verifier 1650 can provide a verification result 1670, which indicates whether the purchase transaction is verified or not. Verification indicates that the one-time credit card number was generated by the customer and whether the signed transaction details were indeed signed by the customer. Such facts indicate that the transaction is indeed valid and can be approved, subject to any other requirements (e.g., whether the customer has sufficient credit, etc.).

### Example 30

### Exemplary Method of Verifying a Transaction Involving a One-Time Credit Card Number

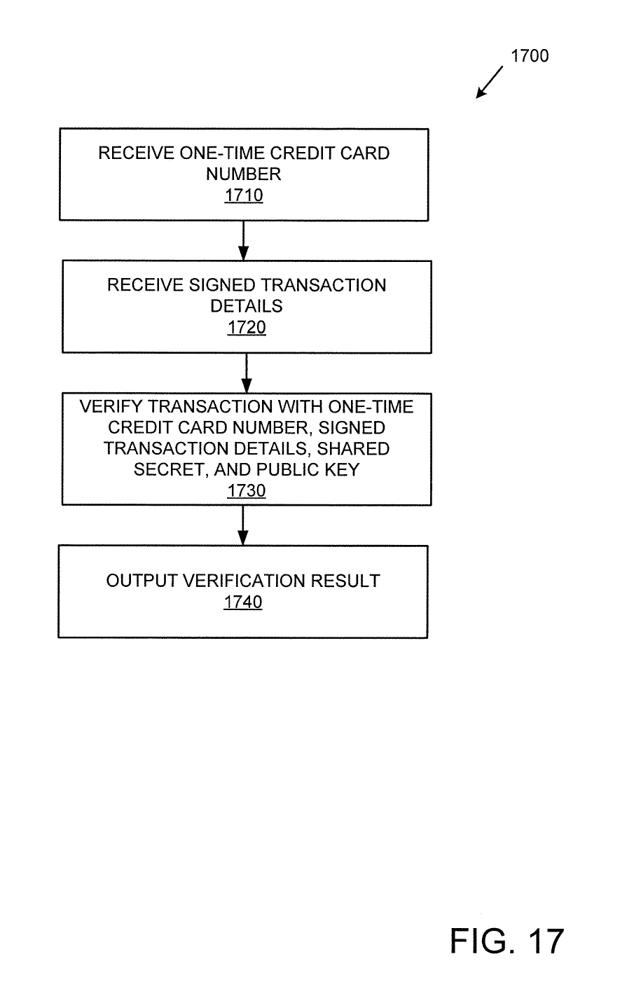

FIG. 17 is a flowchart of an exemplary method 1700 of verifying a transaction involving a one-time credit card number and can be implemented, for example, in a system such as that shown in FIG. 16. In practice, the method 1700 is performed by an issuer device.

At 1710, a one-time credit card number is received. The credit card number is typically received by an issuer device as part of a request for approval of a purchase transaction. A transaction verifier may receive the credit card number as a result of such a request.

At 1720, signed transaction details are received. For example, signed purchase transaction details can be received by an issuer from a customer (e.g., directly or via a merchant).

At 1730, the purchase transaction involving the one-time credit card number is verified with the one-time credit card number, the signed transaction details, the shared secret of the customer, and the public key of the customer.

At 1740, a verification result as described herein is output.

### Example 31

### Exemplary Method of Verifying a One-Time Credit Card Number via a Shared Secret

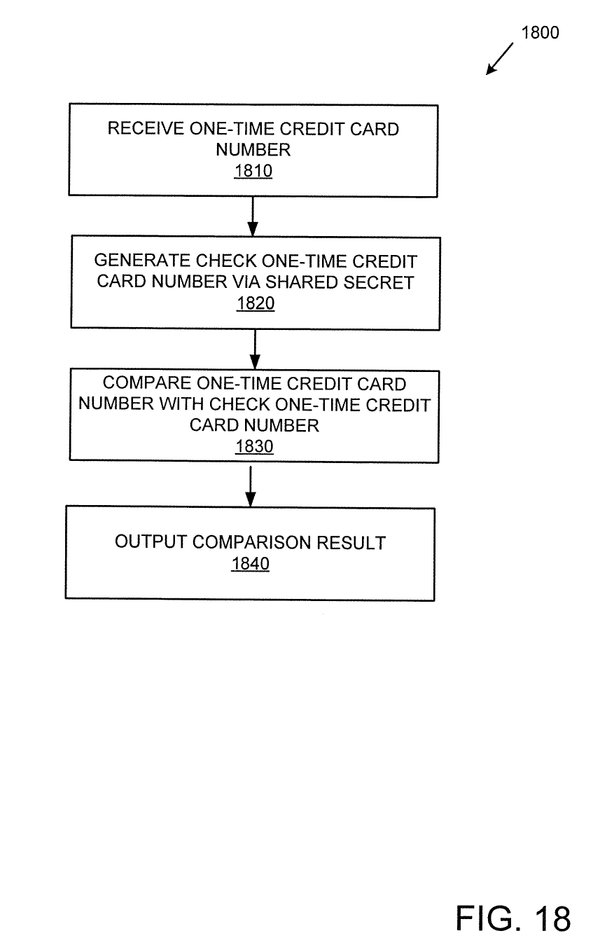

FIG. 18 is a flowchart of an exemplary method 1800 of verifying a one-time credit card number via a shared secret and can be used, for example, in conjunction with the method of FIG. 17.

At 1810, a one-time credit card number is received. As described herein, such a one-time credit card number originates from a customer as part of a purchase transaction. The credit card number is typically sent from the customer device to a merchant device, which then sends the number to the issuer as part of a request for approval of the transaction. The number can be received by a verifier under control of the issuer as a result of receiving such a request.

At 1820, a check one-time credit card number is generated via a shared secret shared as described herein. The same generation technique used by the customer can be used by the issuer to generate the check number.

At 1830, the one-time credit card number and the check one-time credit card number are compared (e.g., to see if they are identical).

At 1840, the result of the comparison are output. For example, if the numbers match, then a positive result (e.g., match, verified, valid, or the like) is output. If the numbers do not match, then a negative result (e.g., no match, not verified, invalid, or the like) is output.

### Example 32

### Exemplary Method of Verifying a One-Time Credit Card Number Transaction Details via a Public Key

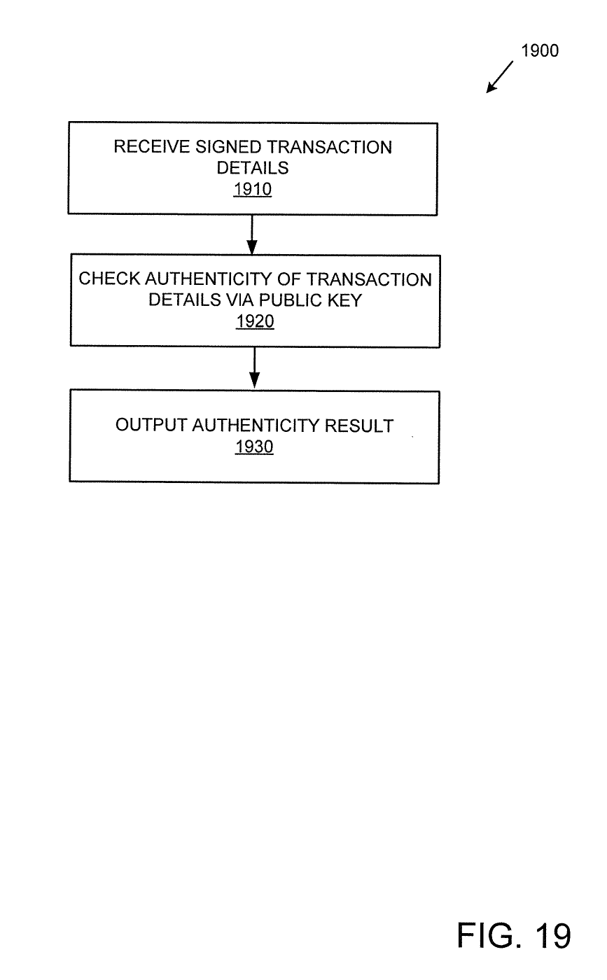

FIG. 19 is a flowchart of an exemplary method 1900 of verifying one-time credit card number transaction details via a public key and can be used, for example, in conjunction with the method of FIG. 17. The method 1900 is typically performed at an issuer device as part of an approval process.

At 1910, digitally signed transaction details for a purchase transaction involving a one-time credit card number are received. As described herein, such details are (e.g., have been) signed with the private key of a customer involved in the transaction.

At 1920, the authenticity of the transaction details are checked via a public key of the customer. Using cryptographic techniques, the public key can be used to determine whether the transaction details were indeed signed with the private key corresponding to the public key, thereby indicating that they were signed by the customer's device.

At 1930, the result of the authenticity check is output. For example, responsive to determining that the transaction details were digitally signed by the customer, a positive result (e.g., valid, authenticated, etc.) is output. Responsive to determining that the transaction details were not digitally signed by the customer, a negative result (e.g., valid, not authenticated, etc.) is output.

### Example 33

### Exemplary System Implementing Initial Setup for One-Time Credit Cards at an Issuer

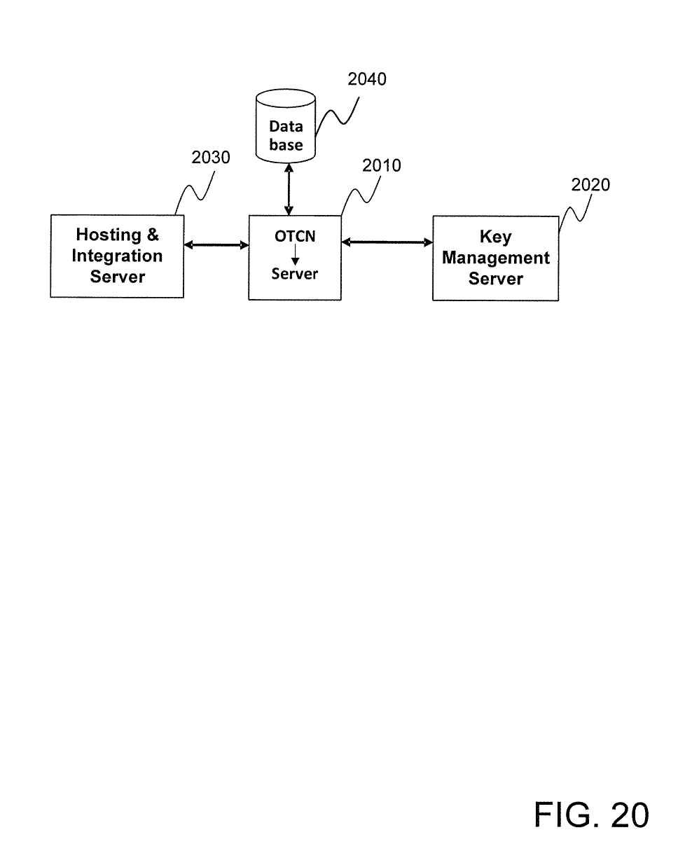

FIG. 20 is a block diagram of an exemplary system configured to implement initial setup for one-time credit cards at an issuer.

The one-time credit card number (OTCN) server 2010 can create personalized applications and support provisioning for users (e.g., customers). The OTCN server 2010 can provide OTCN life cycle management for users and coordinate with the key management server 2020 and the database system 2040.

The key management server 2020 generates unique keys (e.g., shared secrets) for users and subsequently supports key life cycle management for the same.

The hosting and integration server 2030 provides support for hosting the OTCN generation services online and supports subsequent integration of the services with applications.

The database system 2040 hosts the details of the individual users and the data corresponding to the OTCN.

FIG. 20 illustrates overall infrastructure set-up supporting OTCN at the issuer's end. As shown, OTCN server 2010 supports the OTCN life cycle management activities for the users. OCTN life cycle management can include various activities like preparation of personalized OTCN generation software for users, validation of OTCNs submitted by users during transactions, etc. User details are available in a safe storage, typically a database server 2040. The OTCN server 2010 can interact with the database server 2040 for storage needs. The database 2040 can store information of users and can include user details like the user ID, user keys, user OTCN generation data, etc.

The key management server 2020 is responsible for the key life cycle management activities for both issuer and users. Sensitive data that is required for OTCN generation can be stored in encrypted format at both issuer end database server, as well the end user's application. The data can be protected with strong symmetric encryption algorithms. To address the initial key exchange, a symmetric technique using a password based encryption can be used, where the password is shared with the users by the issuer during registration by means of an out of bound channel. Alternatively, the symmetric keys can be encrypted using the public keys of the end users, in which case the end users register their public keys with the issuer during registration.

Key management activities can include key generation, key retrieval based on the user identity etc. The hosting server 2030 can host the OTCN services over the network and integrate with the applications that use OTCN. The hosting server 2030 can be the external interface that provides services like user registration for OTCN, provisioning of personalized OTCN generating applications to users, OTCN validation, etc.

### Example 34

### Exemplary Method Implementing Issuance of a One-Time Credit Card

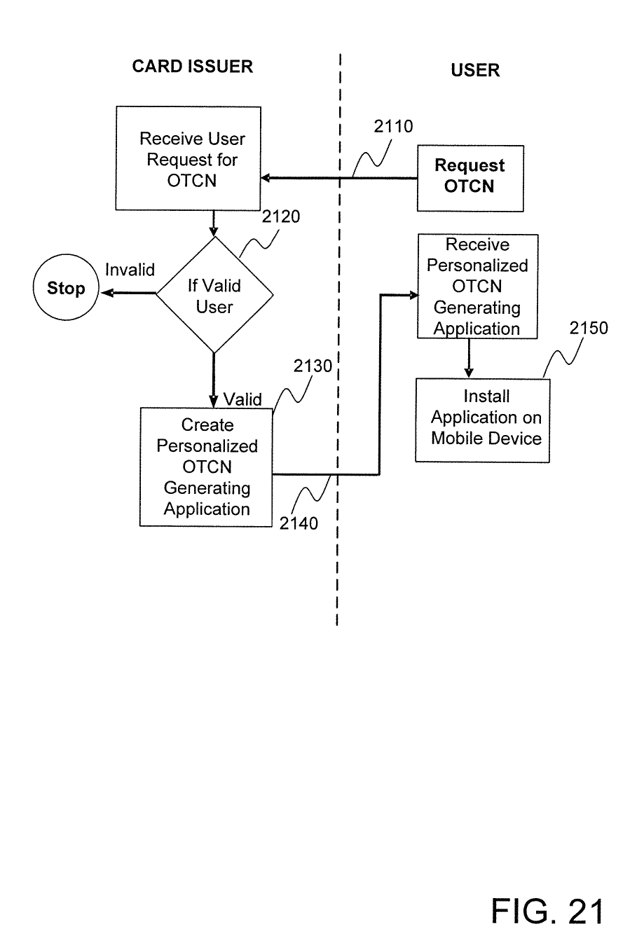

FIG. 21 is a flow diagram of an exemplary method for implementing an issuance process of a one-time credit card.

At 2110, a user (e.g., a customer) requests a OTCN, submitting the user's details and/or credentials that can include information such as encryption key details, unique mobile identification number, and the like, to the OTCN server.

At 2120, upon receipt of the user request, the OTCN server validates the user's credentials.

At 2130, if the user credentials are valid, the OTCN server creates a personalized OTCN-generating application for the user.

At 2140, the OTCN server sends the OTCN-generating application to the user.

At 2150, on receipt of the OTCN-generating application, the user installs the same on the user's mobile device.

FIG. 21 illustrates the process involved in user registration for OTCN and the subsequent provisioning of the OTCN generating software to end users. Users register with the issuer by sending a request for issuance of OTCN generating software. As part of the registration request 2110, end users submit several details to the issuer that include the end user identity, unique mobile identification, etc. The user can also register the user's public key as part of 2110. Alternatively, a user-specific pin/password is stored, and the same is shared with end user by means of out of bound channel. The channel for sharing the pin/password can be anything that includes electronic mail, physical pin mailer, SMS over mobile, etc. In the technique where pin/password is stored, password based encryption techniques can be used to safeguard the OTCN generation data at server and user application.

On receipt of the OTCN registration request, 2120, the issuer validates the user submitted details against the user data stored in database server for authenticity. If the user is a valid user, 2130, the issuer generates a personalized OTCN generation application for that user. The OTCN generation application is unique (e.g., personalized) for every different user so that they generate different OTCNs for different users. OTCN generation applications are personalized by way of sharing unique data securely with the respective application.

A unique random serial number can be generated for a respective user by the server and shared with the application. Alternatively, the mobile unique identification number of the customer device can be used as shared secret. The OTCN generation algorithm takes this shared secret as one of the inputs to produce OTCNs.

The personalized OTCN generation applications are provisioned to the user as part of 2140. This user provisioning of application is handled through the Hosting and Integration server depicted in FIG. 20. On receipt of the application, the user installs the personalized application on the user's mobile device, 2150, and initializes the application on first invocation supplying appropriate credentials. The initialization process can require a shared Password/PIN. Once the application is initialized, it is ready to generate OTCNs.

### Example 35

### Exemplary Method Implementing Usage of a One-Time Credit Card

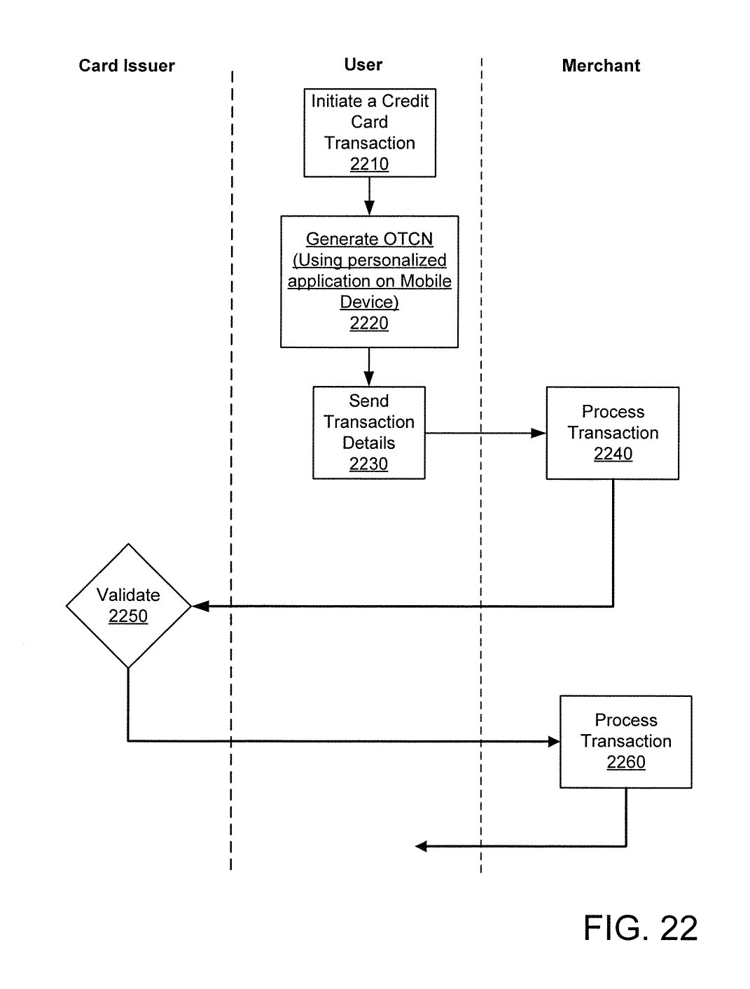

FIG. 22 is a flow diagram of an exemplary method of using a one-time credit card.

At 2210, a user initiates a credit card transaction.

At 2220, a user generates a OTCN on the user's personalized mobile application and validates the user's credentials.

At 2230, the user submits the transaction details along with payment details to the merchant.

At 2240, the merchant processes the transaction and sends the payment relevant details along with the OTCN to the issuer.

At 2250, the issuer validates the OTCN against the user details and sends either an approve or deny status to the merchant.

At 2260, the merchant receives the payment confirmation from the issuer and responds to the user accordingly.

FIG. 22 illustrates the generation of OTCN and its usage in applications. A user initiates a credit card transaction in an application, 2210. One application scenario is where a user does shopping over Internet. The user connects to the merchant's website (e.g., portal), browses through a catalogue provided by the portal, and selects the items the user is interested in buying. The user checks out to purchase items in the shopping cart and proceeds to a payment phase. The user enters details regarding shipping. The user opens up the OTCN generation application on the user's mobile device and supplies the PIN/Password required to generate OTCN. If the user-supplied PIN/Password is valid, the application generates and displays an OTCN on the mobile screen. The user supplies the displayed OTCN along with other details as part of billing/payment details, 2220.

In one embodiment, the user submits the transaction details (e.g., digitally signed) to the merchant. The transaction details include shipping address, payment details (OTCN, amount, etc.), transaction ID, User ID, etc. On receipt of the details the merchant's server process 2230 sends the transaction details (e.g., digitally signed) and payment details (e.g., including the OTCN) to the issuer 2240 for approval.

The issuer on receipt of the payment details validates if the OTCN submitted by the user is valid or not. In one embodiment, the issuer generates the OTCN at server (e.g., issuer) side using the same algorithm and details as those used by the user along with the digitally signed data. If the OTCN is valid, the issuer sends an approval success message; otherwise, the issuer sends an approval failure message to the merchant at 2250. On receipt of the approval confirmation, the merchant sends the corresponding status to the user to close the loop 2260.

### Example 36

### Exemplary Implementation

Any of the technologies described herein can be used to implement one-time credit card numbers, dual controlled generation, and non-repudiable usage using a mobile device.

### Example 37

### Exemplary Implementation

In any of the examples herein, an online or offline transaction can be effected among a user, a merchant system, and an issuer system. The user mobile device generates a one-time credit card number (OTCN) to use for a transaction with the merchant. The user generates the OTCN as a function of various parameters and presents the OTCN to the issuer and to the merchant.

The existing infrastructure is used to convey the credit card number to the issuer, and the issuer performs verification and authentication of the received credit card number using an additional utility as described and responds to the merchant accordingly with the existing mechanism (e.g., to approve or disapprove of the transaction).

### Example 38

### Exemplary Advantages

The techniques described herein for one-time credit card number can support use in a non-repudiable manner using a mobile device. The technologies can be resilient to replay, forgery, man-in-the-middle and guessing attacks for the credit card number generation and usage by an attacker and denial of usage by the original owner.

The techniques herein can also completely remove the requirement of physical delivery of a credit card, thus making the entire process very efficient and secure.

### Example 39

### Exemplary Features

In any of the examples herein, a method of generating and non-repudiable using a one-time credit card number for an online and or offline transaction using a mobile device, can comprise: generating a one-time credit card number at a user mobile device using issuer controlled application; authenticating the user to the issuer application in the user mobile device, user confirming the reading, using and passing the one-time credit card number from the mobile device to the issuer system; passing the one-time credit card number from the mobile device to a merchant system, wherein the merchant system is programmed to present the credit card number to the issuer system to effect a payment; wherein the issuer verify the one-time credit card number received from the merchant system online and or offline; and if the one-time credit card number is verified, approving the transaction.

In any of the examples herein, generating a one-time credit card number by the user/client can comprise executing the issuer supplied and controlled application on the mobile device.

In any of the examples herein, confirming the reading and using of a one-time credit card number can comprise a non-repudiable digitally signed data by the user to the issuer.

In any of the examples herein, the issuer can verify the one-time credit card number received from the merchant system online and/or offline by regenerating the one-time credit card number or by looking in the stored database or combination thereof for the respective user identity and comparing it with the data received from the user.

In any of the examples herein, confirming the reading and usage of one-time credit card number to the issuer can include passing at least one other data element related to user identity.

In any of the examples herein, the at least one other data element can be selected from, or be a function of: a user's account number, derivative of user's private key, a transaction time, a transaction amount, any other element which uniquely identifies the user identity, or a combination thereof.

In any of the examples herein, a process generating and using a one-time credit card number by a mobile device to conduct a credit card based transaction can comprise: generating a user specific executable application for a mobile device; generating a one-time credit card number by a mobile device; generating a digitally signed data by the mobile device for the purpose of integrity, authentication and non-repudiation; accepting and verifying the submitted one-time credit card number by the user; and accepting and verifying the submitted digitally signed data by the user.

### Example 40

### Exemplary Computing Environment

The techniques and solutions described herein can be performed by software, hardware, or both of a computing environment, such as one or more computing devices. For example, computing devices include server computers, desktop computers, laptop computers, notebook computers, netbooks, tablet devices, mobile devices, and other types of computing devices.

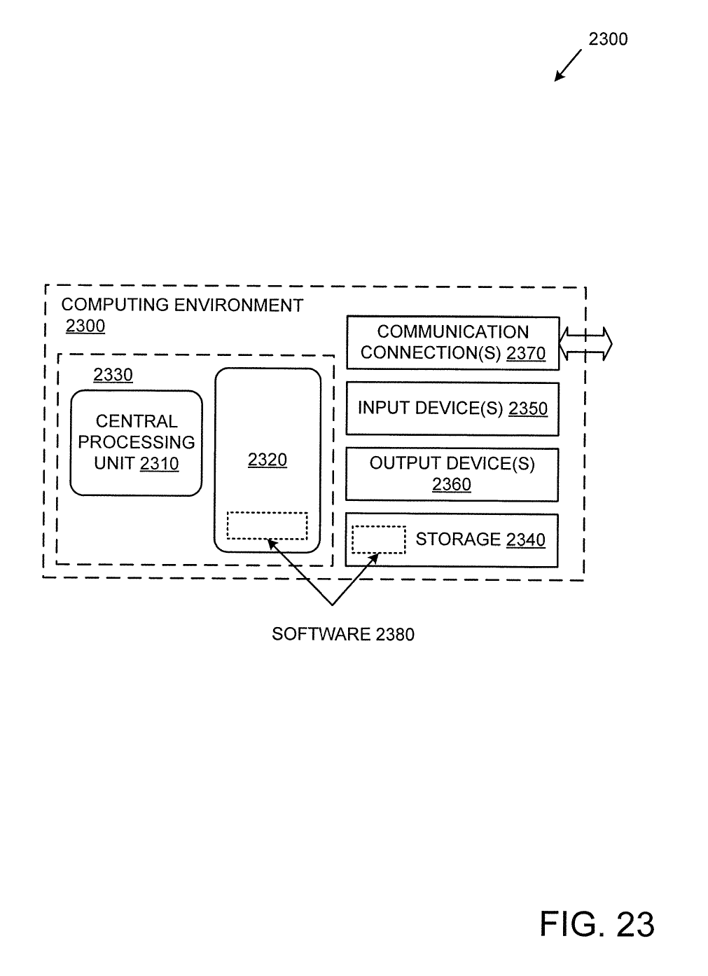

FIG. 23 illustrates a generalized example of a suitable computing environment 2300 in which the described technologies can be implemented. The computing environment 2300 is not intended to suggest any limitation as to scope of use or functionality, as the technologies may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the business value articulation described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like. The disclosed technology may also be practiced in distributed computing environments where tasks are performed by remote processing devices that are linked through a communications network. In a distributed computing environment, program modules may be located in both local and remote memory storage devices

With reference to FIG. 23, the computing environment 2300 includes at least one processing unit 2310 coupled to memory 2320. In FIG. 23, this basic configuration 2330 is included within a dashed line. The processing unit 2310 executes computer-executable instructions and may be a real or a virtual processor. In a multi-processing system, multiple processing units execute computer-executable instructions to increase processing power. The memory 2320 may be volatile memory (e.g., registers, cache, RAM), non-volatile memory (e.g., ROM, EEPROM, flash memory, etc.), or some combination of the two. The memory 2320 can store software 2380 implementing any of the technologies described herein.

A computing environment may have additional features. For example, the computing environment 2300 includes storage 2340, one or more input devices 2350, one or more output devices 2360, and one or more communication connections 2370. An interconnection mechanism (not shown) such as a bus, controller, or network interconnects the components of the computing environment 2300. Typically, operating system software (not shown) provides an operating environment for other software executing in the computing environment 2300, and coordinates activities of the components of the computing environment 2300.

The storage 2340 may be removable or non-removable, and includes magnetic disks, magnetic tapes or cassettes, CD-ROMs, CD-RWs, DVDs, or any other computer-readable media which can be used to store information and which can be accessed within the computing environment 2300. The storage 2340 can store software 2380 containing instructions for any of the technologies described herein.

The input device(s) 2350 may be a touch input device such as a keyboard, mouse, pen, or trackball, a voice input device, a scanning device, or another device that provides input to the computing environment 2300. For audio, the input device(s) 2350 may be a sound card or similar device that accepts audio input in analog or digital form, or a CD-ROM reader that provides audio samples to the computing environment. The output device(s) 2360 may be a display, printer, speaker, CD-writer, or another device that provides output from the computing environment 2300.

The communication connection(s) 2370 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, magnetic disk, CD-ROM, CD-RW, DVD, or the like). Such instructions can cause a computer to perform the method.

Any of the storing actions described herein can be implemented by storing in one or more computer-readable storage devices.

Any of the things described as stored can be stored in one or more computer-readable storage devices.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of these claims.

We claim:

1. A method, implemented at least in part by a computing device, the method comprising:
receiving a one-time credit card number for a purchase transaction being made via a customer device;
receiving signed purchase transaction details of the purchase transaction originating from the customer device;
via a shared secret shared with the customer device and the signed purchase transaction details, determining whether the one-time credit card number is valid; and
responsive to determining that the one-time credit card number is valid, outputting an indication of validity of the purchase transaction.

2. One or more computer-readable storage devices having encoded therein computer-executable instructions causing a computer to perform the method of claim 1.

3. The method of claim 1, wherein:
the one-time credit card number originates from the customer device.

4. The method of claim 1, wherein:
the one-time credit card number is of a format and syntax of a conventional credit card number.

5. The method of claim 1, wherein:
determining whether the one-time credit card number is valid comprises:
generating, via the shared secret shared with the customer device, a check one-time credit card number; and
determining whether the one-time credit card number and the check one-time credit card number match.

6. The method of claim 1, wherein:
determining whether the one-time credit card number is valid comprises:
verifying the signed transaction details with a public key of a customer engaging in the purchase transaction.

7. The method of claim 1, wherein:
the signed purchase transaction details are signed with a private key of a customer engaging in the purchase transaction.

8. The method of claim 1, wherein:
the one-time credit card number is not provided to the customer device by a device controlled by an issuer.

9. The method of claim 1, wherein:
the one-time credit card number is not provided to the customer device before generation by the customer device.

10. The method of claim 1, wherein:
the purchase transaction is conducted offline.

11. The method of claim 1, wherein:
the one-time credit card number and the signed transaction details are sent via different communication channels.

12. The method of claim 1, wherein:
the signed purchase transaction details comprise:
the one-time credit card number; and
an identifier identifying a customer operating the customer device.

13. A method, implemented at least in part by a computing device, the method comprising:
in a customer controlled device, generating, with a one-time credit card number generation application having as input shared secret shared with an issuer, a one-time credit card number;
outputting the one-time credit card number for use in a purchase being made by a customer from a merchant;
generating signed purchase transaction information, the generating comprising signing, with the shared secret, purchase transaction information for the purchase being made by the customer from the merchant; and
outputting the signed purchase transaction information.

14. The method of claim 13 wherein the one-time credit card number originates from the customer controlled device.

15. The method of claim 13 wherein:
the one-time credit card number is generated by an application authorized by an issuer but without receiving additional information from the issuer.

16. The method of claim 13 wherein:
the one-time credit card number and the signed purchase transaction information are sent via different channels.

17. The method of claim 13 wherein:
the one-time credit card number and the signed purchase transaction information are sent via a same channel.

18. The method of claim 13 wherein:
the one-time credit card number has a format of a convention credit card number.

19. One or more computer-readable storage devices comprising:
an infrastructure-transparent one-time credit card number;
wherein the infrastructure-transparent one-time credit card number is generated by a customer device responsive to a request for a new one-time credit card number without receiving information from an issuer after receipt of the request.

20. One or more computer-readable storage devices comprising computer-executable instructions for performing a method comprising:
receiving a request to generate a new one-time credit card number;
responsive to the request, generating, at a customer device, the one-time credit card number, wherein the one-time credit card number is of a format of a standard credit card number, wherein the generating is based at least on a shared secret shared with an issuer, and wherein the one-time credit card number is generated without receiving information from the issuer after receiving the request to generate the new one-time credit card number;
generating signed details of a purchase transaction conducted between a customer and a merchant, wherein the generating comprises signing details of the purchase transaction with a private key of the customer, wherein the details comprise an identity of the customer and the one-time credit card number;
sending the one-time credit card number to the merchant for the purchase transaction conducted between the customer and the merchant; and
sending the signed details of the purchase transaction to the issuer.

21. The one or more computer-readable storage devices of claim 20 wherein the method further comprises:
receiving a one-time credit card number generation application from the issuer;
wherein generating the one-time credit card number comprises:
generating the one-time credit card number with the one-time credit card number generation application.
